(19) United States
(12) Patent Application Publication
(10) Pub. No.: US 2017/0207590 A1
(43) Pub. Date: Jul. 20, 2017

(54) HERMAPHRODITIC CONNECTOR SYSTEM

(71) Applicant: J.S.T. CORPORATION, Farmington Hills, MI (US)

(72) Inventors: Ryan DOMBROWSKI, Ann Arbor, MI (US); Franklin A. HOLUB, West Bloomfield, MI (US)

(73) Assignee: J.S.T. CORPORATION, Farmington Hills, MI (US)

(21) Appl. No.: 15/404,429

(22) Filed: Jan. 12, 2017

Related U.S. Application Data
(60) Provisional application No. 62/279,094, filed on Jan. 15, 2016.

(51) Int. Cl. H01R 24/84; H01R 13/26; H01R 13/627

(52) U.S. Cl. CPC H01R 24/84; H01R 13/6273; H01R 13/26

(57) ABSTRACT

A hermaphroditic connector has a housing having a mating portion, including an inner wall and an outer wall in the mating portion of the connector, and including a bottoming surface having at least one cavity for receiving a terminal. The inner wall is integrally made from an inner wall connecting portion and two side portions, and the outer wall is integrally made from an outer wall connecting portion and two side portions. The inner wall is of a shape such that when two of the hermaphroditic connectors are mated, the inner wall of each hermaphroditic connector will fit inside the outer wall of the mating connector. The hermaphroditic connector can be used with hermaphroditic electrical terminals and is useful in automotive applications.

### CROSS-REFERENCE TO RELATED APPLICATIONS

This application claims priority of U.S. provisional application Ser. No. 62/279,094, filed Jan. 15, 2016.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### STATEMENT REGARDING PRIOR DISCLOSURES BY THE INVENTOR OR A JOINT INVENTOR

Not applicable.

### BACKGROUND OF THE INVENTION

Field of the Invention

The present invention generally relates to the field of electrical connectors, which are useful in automotive applications.

Description of the Related Art

Hermaphroditic (genderless) electrical connectors are connectors that mate at 180° around the longitudinal axis to themselves.

For example, US Patent Publication 2002/0168901 discloses a genderless, high current electrical connector with auxiliary contacts, for use in charging stations to swap battery packs for material handling vehicles.

### BRIEF SUMMARY OF THE INVENTION

The hermaphroditic connector system of the present invention includes a hermaphroditic connector having a housing having a mating portion, including an inner wall and an outer wall in the mating portion of the connector, and including a bottoming surface having at least one cavity for receiving a terminal. The inner wall is integrally made from an inner wall connecting portion and two inner wall side portions, and the outer wall is integrally made from an outer wall connecting portion and two outer wall side portions. The inner wall is of a shape such that when two of the hermaphroditic connectors are mated, the inner wall of each hermaphroditic connector will fit inside the outer wall of the mating connector.

The hermaphroditic connector may also include ribs on the exterior faces of the inner wall side portions and grooves on the interior faces of the outer wall side portions, such that when two of the hermaphroditic connectors are mated, the ribs of each hermaphroditic connector fit inside the grooves of the other hermaphroditic connector.

The bottoming surface of the connector may have a plurality of cavities in different configurations having the symmetry required by a hermaphroditic connector

The connector may have a latch for latching two of the hermaphroditic connectors when mated.

The hermaphroditic connector can be used with hermaphroditic electrical terminals inserted in cavities of the bottoming surface.

The connector system of the invention is useful in automotive applications.

### BRIEF DESCRIPTION OF THE SEVERAL VIEWS OF DRAWINGS

FIG. 1 is a perspective view of one embodiment of the hermaphroditic connector of the present invention.

FIG. 2 is a side plan view of the connector shown in FIG. 1.

FIG. 3 is a cross-sectional view along dotted line 3 in FIG. 2.

FIG. 4 is a perspective view of two of the connectors of FIG. 1 aligned for mating.

FIG. 5 is a perspective view of two of the connectors of FIG. 1 mated with each other.

FIG. 6 is a side plan view of the two mated connectors shown in FIG. 5.

FIG. 7 is a cross-sectional view along dotted line 7 in FIG. 6.

FIGS. 8A to 8D illustrate sectional views of embodiments of the invention having different numbers of cavities.

FIGS. 9 is a longitudinal cross-sectional view of two mated connectors of the invention including mated exemplary terminals.

FIG. 10 is a perspective view of an embodiment of the present invention including a drawer style terminal position assurance (TPA).

FIG. 11 is a perspective view of an embodiment of the present invention including a side load style terminal position assurance (TPA).

### DETAILED DESCRIPTION OF THE INVENTION

The present invention provides a hermaphroditic connector system for electrical components, which is useful, for example, in the automotive industry. The present invention can be understood in view of the embodiments described below.

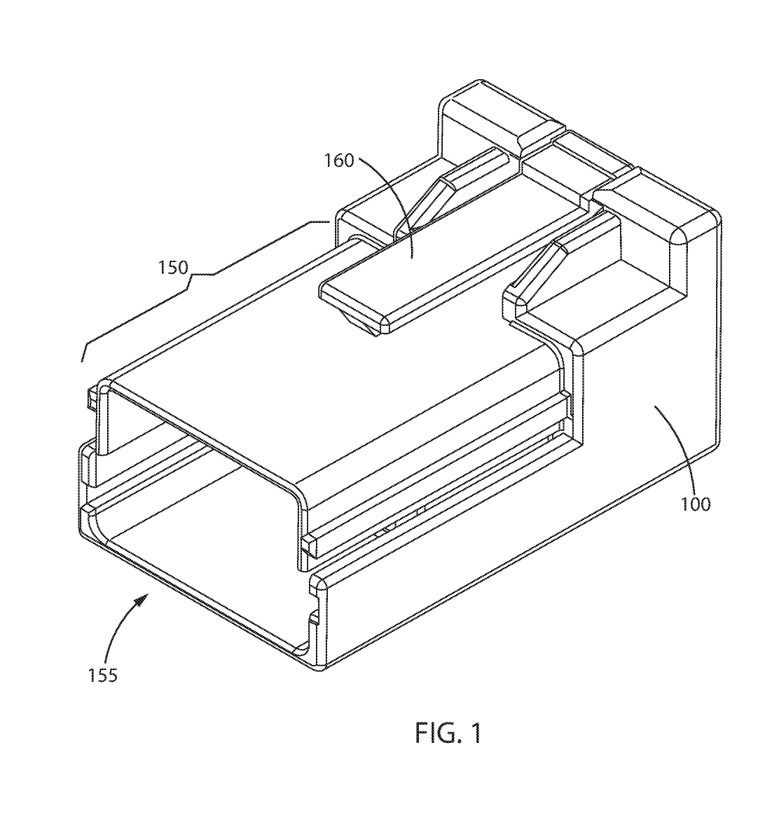

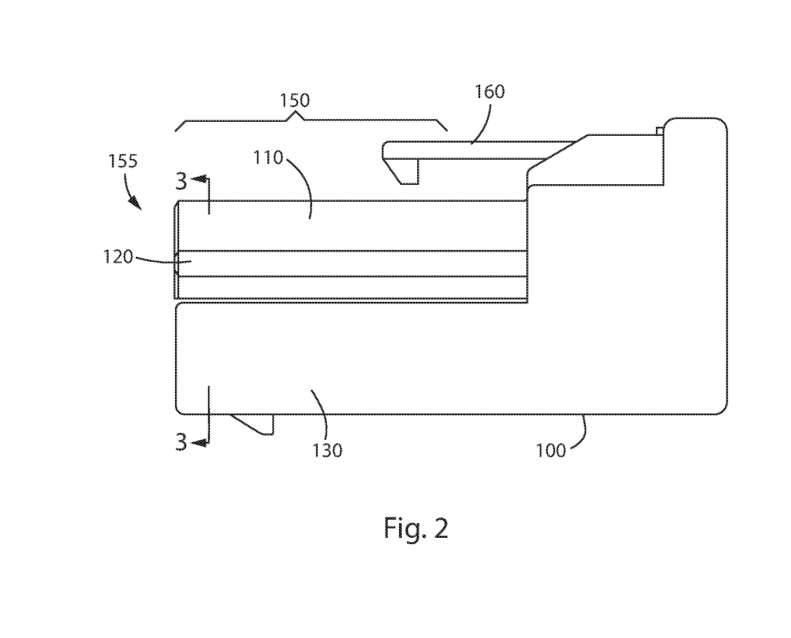

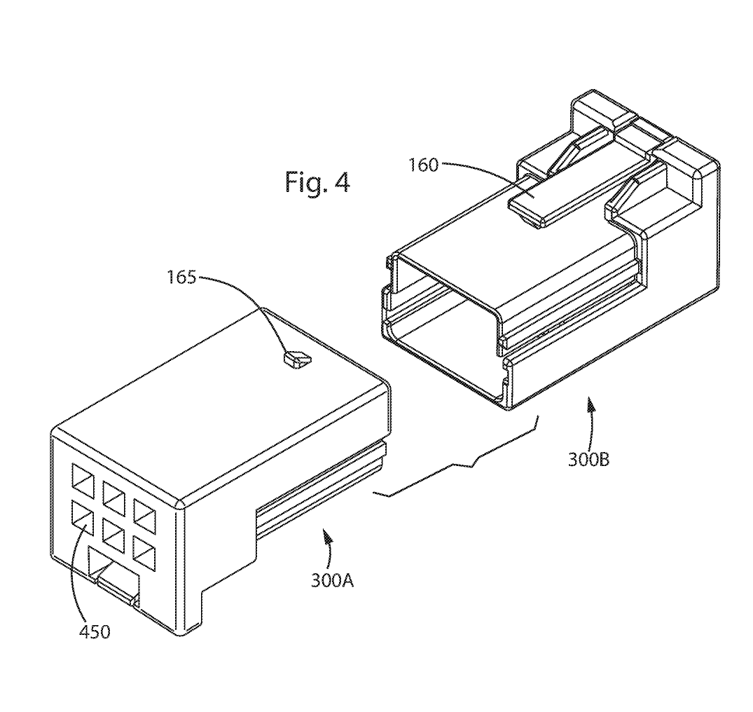

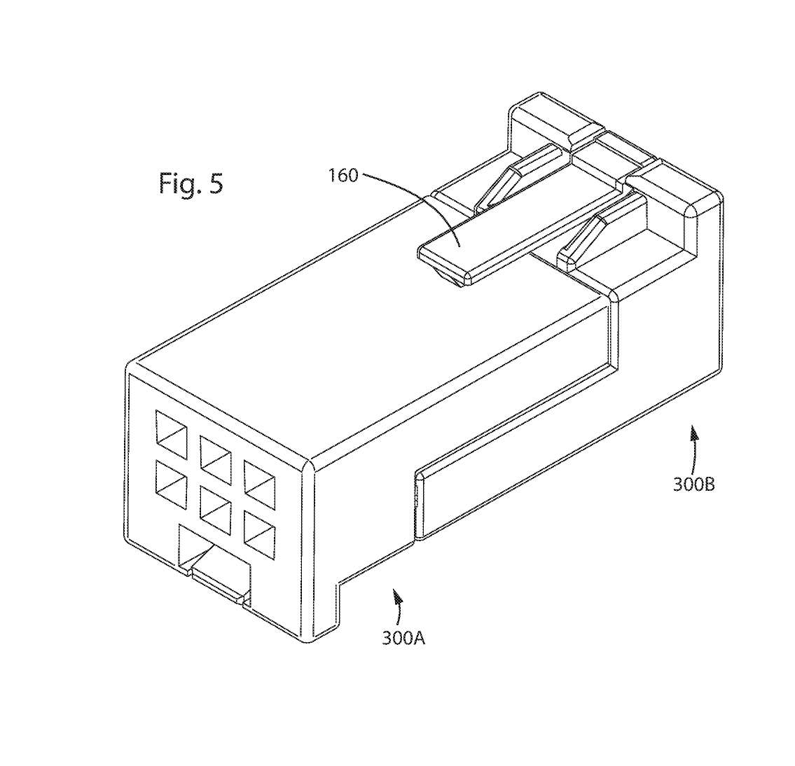

The hermaphroditic connector system of the invention includes a hermaphroditic connector. One embodiment of the hermaphroditic connector of the present invention is illustrated in FIGS. 1 and 2. The connector has a housing 100, and is of a structure such that two connectors can mate with each other at their mating ends 155 when one connector is rotated 180° to the other, as shown in FIG. 4. The connectors in this orientation can be pushed together and mated, as shown in FIG. 5. The connector will typically have a latch 160 with corresponding catch 165 on the opposite side of the connector, as shown in FIG. 4, such that the two connectors are latched when mated.

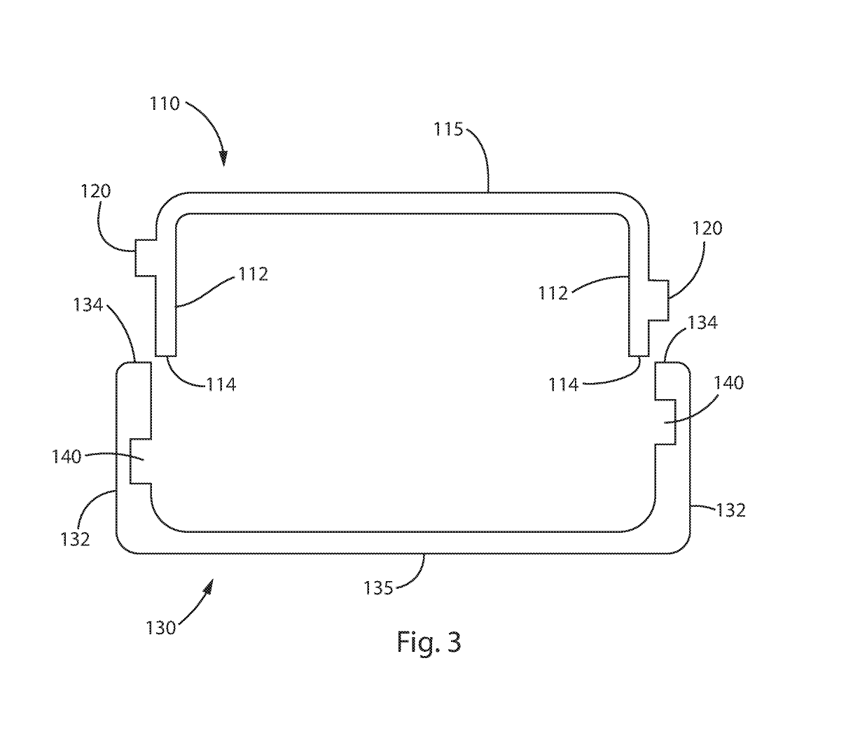

As seen in FIG. 2, the housing 100 includes a mating portion 150 extending from mating end 155 for a portion of the length of the connector, and the contact between the connectors occurs in mating portion 150. In the mating portion 150, the housing 100 of one connector has an inner wall 110 and an outer wall 130. As seen in FIG. 3, which is a cross-sectional view of the structure shown in FIG. 2 through the mating portion 150 in a region near the mating end 155, the inner wall 110 includes a connecting portion 115 integral with two side portions 112, which are at right angles to the connecting portion 115. The housing maintains this general cross-section in a region extending some distance back from the mating end.

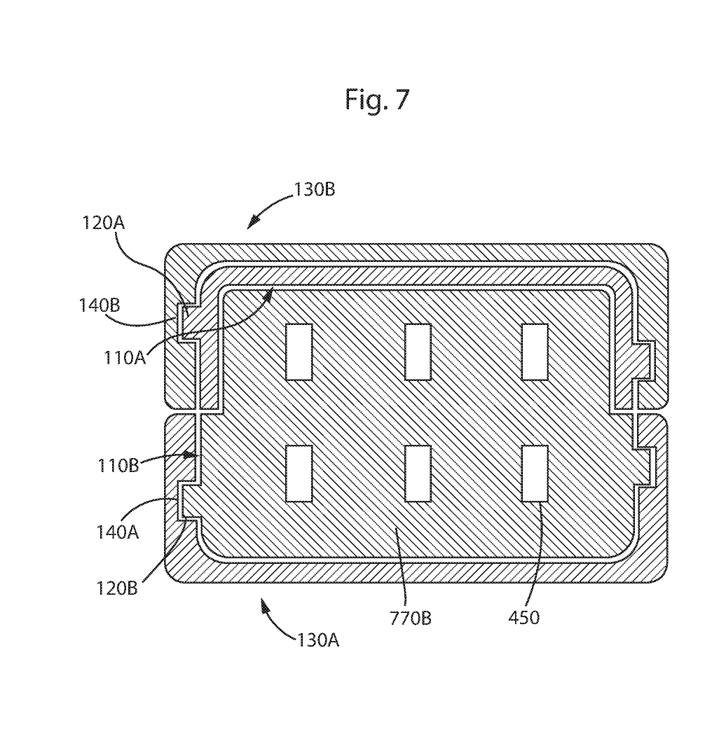

The outer wall 130 includes a connecting portion 135 that is parallel to connecting portion 115 of the inner wall 110, and is integral with two side portions 132 at right angles to the connecting portion 135. The side portions 112 of the inner wall 110 and the side portions 132 of heights such that the edges 114 of the side portions of the inner wall align with the edges 134 of the side portions of the outer wall, as shown in FIG. 3. The inner wall 110 and outer wall 130 are of shape such that the inner wall 110 of one hermaphroditic connector will fit inside the outer wall 130 of another of the same hermaphroditic connector when the two hermaphroditic connectors are mated, as shown in FIG. 7. It will be understood that the fit of the inner wall inside the outer wall will be a snug fit with relatively little gap, as will be understood in the art of connectors.

The exterior face of each side portion 112 (that is, the face facing away from the other side portion 112) may be flat. Optionally, in the embodiment illustrated in FIGS. 1-4 and 7, the exterior face of each side portion 112 has a rib 120 running parallel to the longitudinal axis (that is, in the direction from the mating end toward the end opposite the mating end). The interior face of each side portion 132 (that is, the face facing toward the other side portion 132) has a complementary groove 140 running parallel to the longitudinal axis. The ribs 120 and the grooves 140 are complementary in that ribs 120 will fit into grooves 140 when two of the connectors are mated. The ribs and grooves can serve as keying features so that the hermaphroditic connector cannot be mated to a hermaphroditic connector with a different configuration.

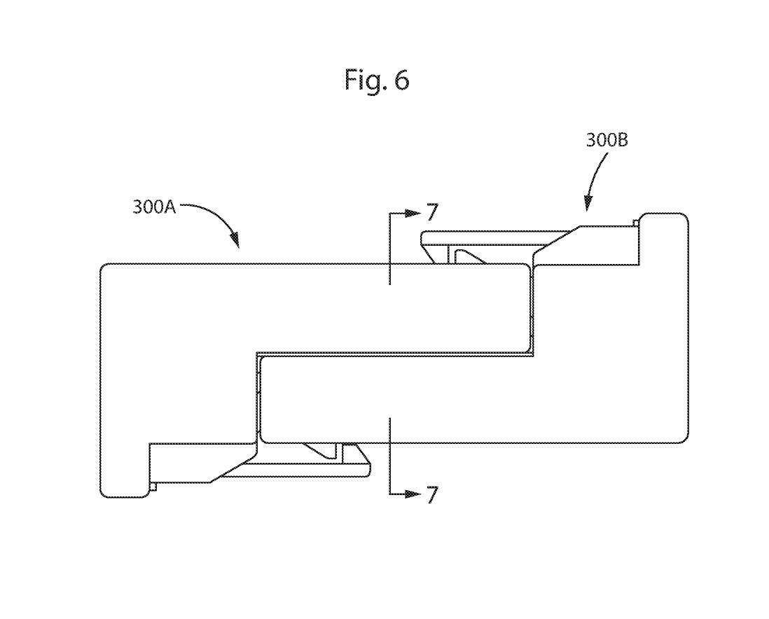

FIG. 4 illustrates two identical hermaphroditic connectors 300A and 300B aligned for mating, and FIGS. 5 and 6 illustrate connectors 300A and 300B mated with each other.

FIG. 7 illustrates a cross-sectional view of the mated connectors shown in FIG. 6. In FIG. 7, respective inner walls 110A and 110B and outer walls 130A and 130B of the two connectors can be seen. The engagement of rib 120A with groove 140B and the engagement of rib 120B with groove 140A is illustrated.

In the embodiment shown in FIG. 4, there are six cavities 450 for receiving the terminals that will be connected. Since the connectors are hermaphroditic, in use, each terminal will receive hermaphroditic terminals in its cavities, such that when the connectors are mated, each terminal of one connector will mate with a corresponding terminal of the other connector.

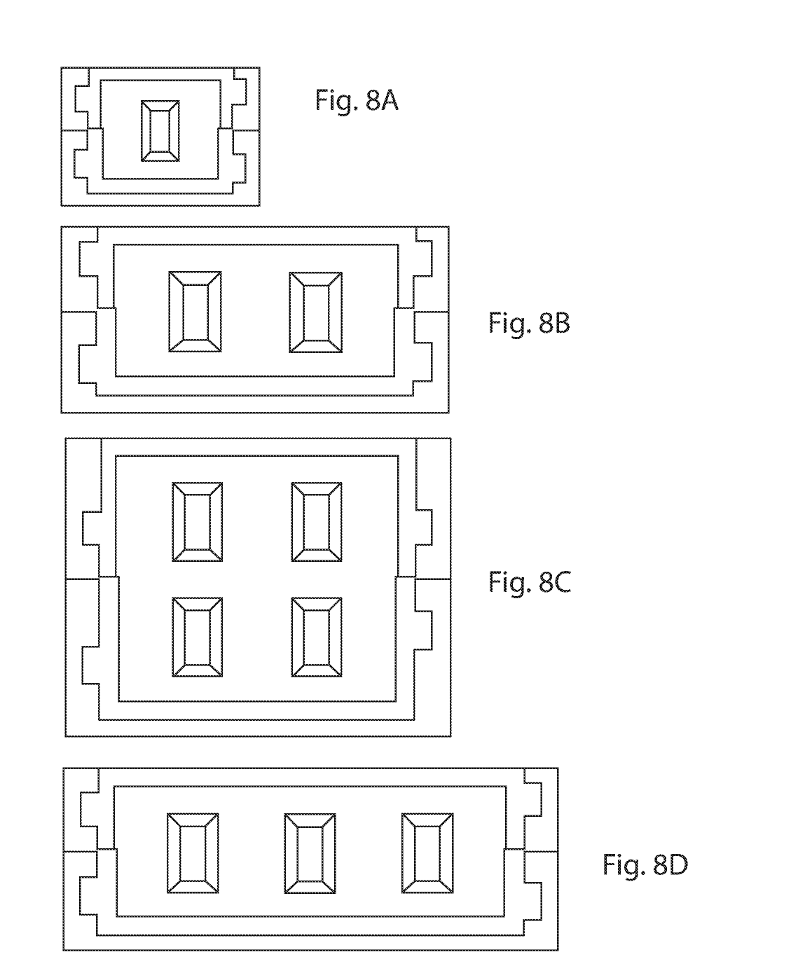

The cross-section shown in FIG. 7 runs through bottoming surface 770B of connector 300B, the bottoming surface being integral with inner wall 110B in this portion of the connector. In the embodiment shown in FIGS. 4-7, there are six cavities 450 arranged in a 2-by-3 configuration. Other configurations are possible, as long as they retain the symmetry required by the hermaphroditic connector. For example, FIG. 8A illustrates a single connector embodiment. FIG. 8B illustrates a 2-connector embodiment (one row). FIG. 8C illustrates a 4-connector embodiment (2-by-2). FIG. 8D illustrates a 3-connector embodiment (one row).

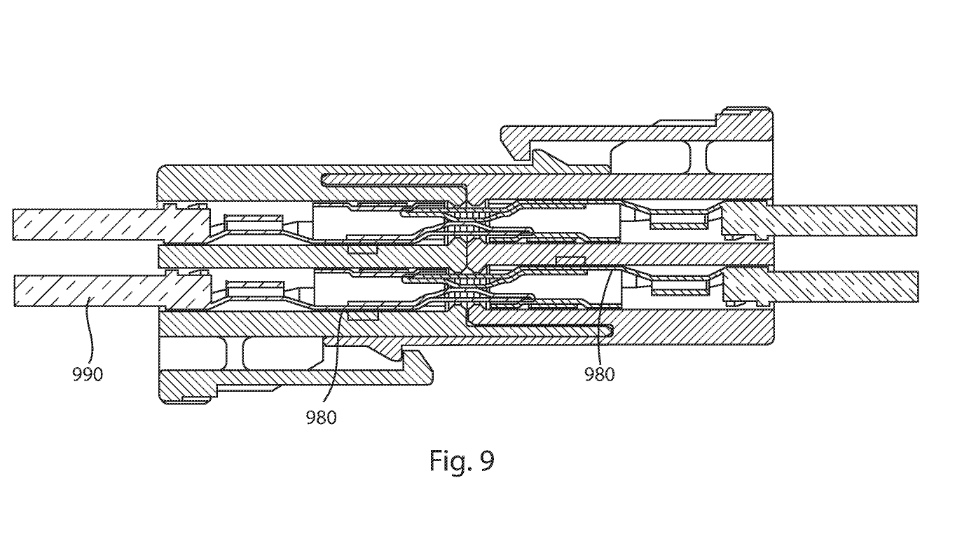

FIG. 9 illustrates a vertical cross-section through the mating pair of connectors shown in FIG. 6, in the state where exemplary hermaphroditic terminals 980 are present in the cavities. The hermaphroditic terminals 980 are attached to cables 990 extending out of the connectors.

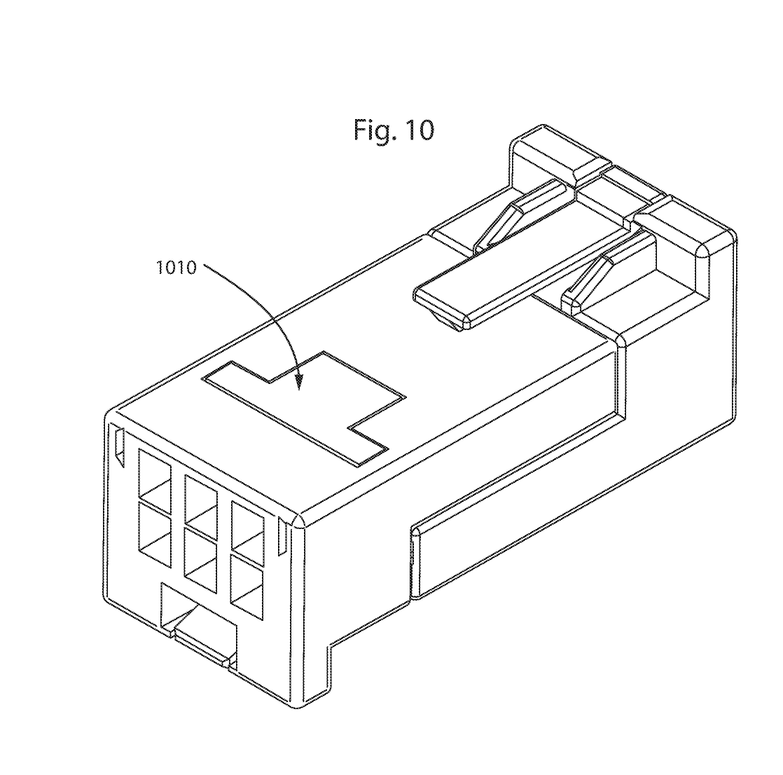

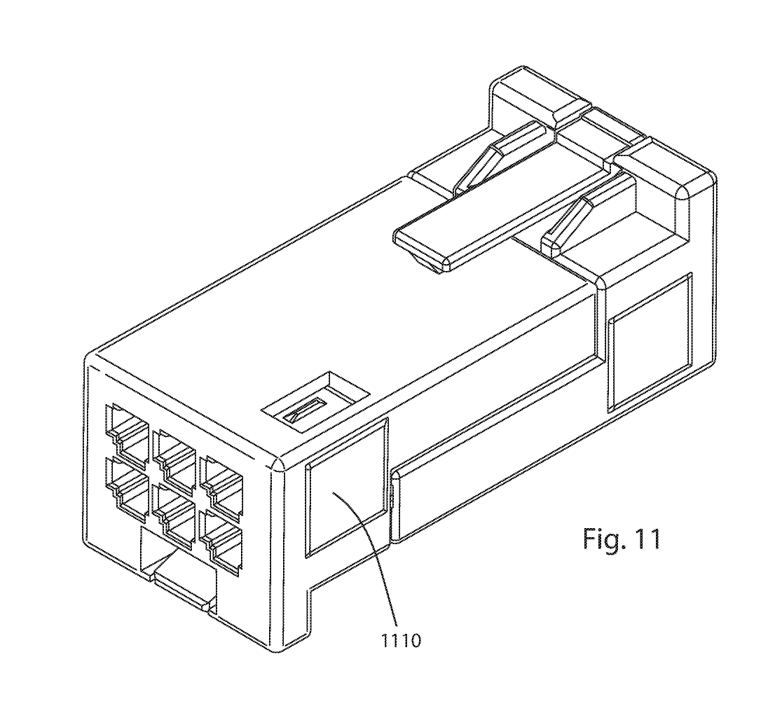

The hermaphroditic terminal of the invention can incorporate known terminal position assurance (TPA) configurations. For example, in FIG. 10, two mated terminals of the invention are shown including a drawer style TPA 1010. Drawer style TPAs are known in the art and one of skill in the art can easily design a drawer style TPA for use with the connector of the invention. In FIG. 11, two mated terminals of the invention are shown including a side load style TPA 1110. Side load style TPAs are known in the art and one of skill in the art can easily design a side load style TPA for use with the connector of the invention.

It will be understood that the invention has been shown and described with respect to specific embodiments, but that the invention is not limited to these specific embodiments.

### LIST OF REFERENCE NUMERALS

100 Housing
110 Inner wall of housing
112 Side portion of inner wall
114 Edge of side portion of inner wall
115 Connecting portion of inner wall
120 Rib
130 Outer wall of housing
132 Side portion of outer wall
134 Edge of side portion of outer wall
135 Connecting portion of outer wall
140 Groove
150 Mating portion
155 Mating end
160 Latch
770 Bottoming surface
980 Hermaphroditic terminal
990 Cable
1010 Drawer style TPA
1110 Side load style TPA

1. A hermaphroditic connector, comprising:
a housing, said housing having a mating portion extending from one end of the connector for a portion of the distance toward the opposite end of the connector;
wherein said housing comprises:
an inner wall in the mating portion of the connector;
an outer wall in the mating portion of the connector; and
a bottoming surface having at least one cavity for receiving a terminal;
wherein said inner wall comprises:
an inner wall connecting portion; and
two inner wall side portions, each at a right angle to said inner wall connecting portion, said connecting portion being integral with said two inner wall side portions;
wherein said outer wall comprises:
an outer wall connecting portion parallel to said inner wall connecting portion; and
two outer wall side portions, each at a right angle to said outer wall connecting portion, said outer wall connecting portion being integral with said two outer wall side portions;
wherein said inner wall is of a shape such that when two of the hermaphroditic connectors are mated, the inner wall of each hermaphroditic connector will fit inside the outer wall of the other hermaphroditic connector.

2. The hermaphroditic connector of claim 1, further comprising:
two ribs, one rib on the exterior face of each inner wall side portion, the ribs running parallel to the direction from the mating end to the opposite end of the connector; and
two grooves, one groove on the interior face of each outer wall side portion, the grooves running parallel to the direction from the mating end to the opposite end of the connector;
wherein said grooves are of a shape such that when two of the hermaphroditic connectors are mated, the ribs of each hermaphroditic connector will fit inside the grooves of the other hermaphroditic connector.

3. The hermaphroditic connector of claim 1, further comprising:
a latch on an exterior portion of said housing, for latching two of the hermaphroditic connectors when mated.

4. The hermaphroditic connector of claim 3, wherein:
said latch extends from the end of the connector opposite the mating end in a location exterior to the inner wall of the housing; and
wherein the exterior of the outer wall comprises a catch for engaging the latch of a mating hermaphroditic connector.

5. The hermaphroditic connector of claim 1, wherein:
said bottoming surface has a single cavity for accepting a terminal.

6. The hermaphroditic connector of claim 1, wherein:
said bottoming surface has a single row having two cavities for accepting terminals.

7. The hermaphroditic connector of claim 1, wherein:
said bottoming surface has a single row having three cavities for accepting terminals.

8. The hermaphroditic connector of claim 1, wherein:
said bottoming surface has two rows having two cavities each for accepting terminals.

9. The hermaphroditic connector of claim 1, wherein:
said bottoming surface has two rows each having a plurality of cavities for accepting terminals.

10. The hermaphroditic connector of claim 1, further comprising:
a hermaphroditic terminal located in a cavity of the bottoming surface.

11. The hermaphroditic connector of claim 1, further comprising:
a drawer style terminal position assurance.

12. The hermaphroditic connector of claim 1, further comprising:
a side load style terminal position assurance.
